(19) United States
(12) Patent Application Publication
(10) Pub. No.: US 2025/0282142 A1
(43) Pub. Date: Sep. 11, 2025

(54) LIQUID EJECTION APPARATUS AND CONTROL METHOD FOR LIQUID EJECTION APPARATUS

(71) Applicant: SEIKO EPSON CORPORATION, TOKYO (JP)

(72) Inventors: Taku ISHIZAWA, MATSUMOTO-SHI (JP); Yuta KOMATSU, SHIOJIRI-SHI (JP); Makoto SAWADAISHI, SHIOJIRI-SHI (JP)

(21) Appl. No.: 19/076,073

(22) Filed: Mar. 11, 2025

(30) Foreign Application Priority Data
Mar. 11, 2024 (JP) 2024-036751

(51) Int. Cl. B41J 2/17; B41J 2/175

(52) U.S. Cl. CPC B41J 2/1728; B41J 2/17566; B41J 2002/17573

(57) ABSTRACT

A liquid ejection apparatus includes a liquid ejection unit configured to eject liquid and a control unit. The control unit executes calculation processing of calculating an evaporation amount of waste liquid by which the waste liquid evaporates from a waste liquid container provided with an atmosphere opening hole, and estimation processing of estimating a contained amount of the waste liquid contained in the waste liquid container, based on an additional amount of the waste liquid by which the liquid ejected by the liquid ejection unit is added to the waste liquid container as the waste liquid and a result in the calculation processing.

The present application is based on, and claims priority from JP Application Serial Number 2024-036751, filed Mar. 11, 2024, the disclosure of which is hereby incorporated by reference herein in its entirety.

### BACKGROUND

### 1. Technical Field

The present disclosure relates to a liquid ejection apparatus and a control method for the liquid ejection apparatus.

### 2. Related Art

For example, Japanese Patent Application Laid-Open No. 2003-145793 discloses a liquid ejection apparatus to which a waste liquid container can be attached, and liquid ejected from a liquid ejection unit is contained as waste liquid in the waste liquid container. In such a liquid ejection apparatus, a liquid amount detection unit can detect that the contained amount of the waste liquid has reached the upper limit contained amount.

Furthermore, as such a liquid ejection apparatus, there is also known an apparatus that calculates the contained amount of the waste liquid contained in the waste liquid container based on the additional amount of the waste liquid added to the waste liquid container and issues a notification related to the contained amount of the waste liquid contained in the waste liquid container. For example, a notification for the replacement of the waste liquid container can be issued in advance, with a notification issued indicating that the contained amount of the waste liquid contained in the waste liquid container has reached a prescribed contained amount less than the upper limit contained amount.

The waste liquid container includes a container provided with an atmosphere opening hole in order to increase the contained amount of the waste liquid. When such a waste liquid container is used, the evaporation of the waste liquid can be promoted through the atmosphere opening hole.

However, with such a liquid ejection apparatus in which the contained amount of the waste liquid contained in the waste liquid container is estimated, there is a concern that the estimation accuracy of the contained amount of the waste liquid may be compromised due to a decrease in the contained amount of the waste liquid depending on the evaporation amount of the waste liquid. In view of the above, there has been a demand for improvement in the function related to the contained amount of the waste liquid contained in the waste liquid container.

### SUMMARY

A liquid ejection apparatus to satisfy the demand described above includes a liquid ejection unit configured to eject liquid, a liquid amount detection unit configured to detect, in a waste liquid container configured to contain liquid ejected by the liquid ejection unit as waste liquid, that a contained amount of waste liquid contained in the waste liquid container reaches a threshold, and a control unit, the control unit being configured to execute calculation processing of calculating an evaporation amount of waste liquid when waste liquid contained in the waste liquid container evaporates from the waste liquid container provided with an atmosphere opening hole, and estimation processing of estimating a contained amount of waste liquid contained in the waste liquid container, based on an additional amount of waste liquid when liquid ejected by the liquid ejection unit is added to the waste liquid container as waste liquid and a calculation result in the calculation processing.

A control method for a liquid ejection apparatus to satisfy the demand described above is a control method for a liquid ejection apparatus configured to perform control related to a contained amount of waste liquid that is liquid ejected by a liquid ejection unit and contained in a waste liquid container as waste liquid, the control method including executing determination processing of determining that a contained amount of waste liquid contained in the waste liquid container reaches a threshold, based on a detection result by a liquid amount detection unit, calculation processing of calculating an evaporation amount of waste liquid when waste liquid contained in the waste liquid container evaporates from the waste liquid container provided with an atmosphere opening hole, and estimation processing of estimating a contained amount of waste liquid contained in the waste liquid container, based on an additional amount of waste liquid when liquid ejected by the liquid ejection unit is added to the waste liquid container as waste liquid and a calculating result in the calculation processing.

### BRIEF DESCRIPTION OF THE DRAWINGS

FIG. 1 is a schematic view illustrating a liquid ejection apparatus according to a first embodiment.

FIG. 2 is a perspective view illustrating a waste liquid container according to the first embodiment.

FIG. 3 is a perspective view illustrating the waste liquid container according to the first embodiment.

FIG. 4 is a flowchart illustrating waste liquid control processing according to the first embodiment.

FIG. 5 is a timing chart illustrating the relationship between a waste liquid contained amount and time according to the first embodiment.

FIG. 6 is a perspective view illustrating a waste liquid container according to a second embodiment.

FIG. 7 is a flowchart illustrating waste liquid control processing of the second embodiment.

### DESCRIPTION OF EMBODIMENTS

### First Embodiment

An embodiment of a liquid ejection apparatus and a control method for the liquid ejection apparatus will be described below with reference to the drawings.

### Configuration of Liquid Ejection Apparatus 10

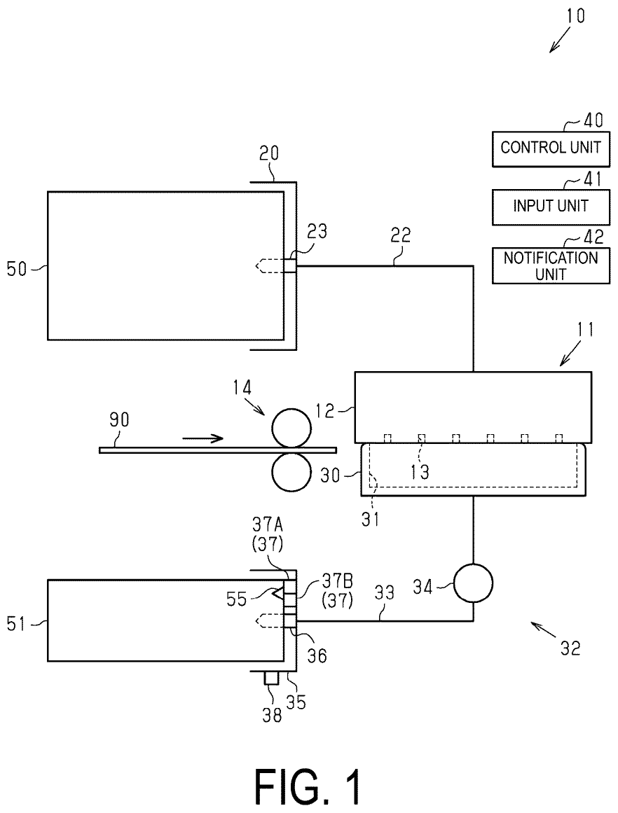

A liquid ejection apparatus 10 is configured to perform printing by ejecting liquid onto a medium 90, as illustrated in FIG. 1. The liquid ejection apparatus 10 may be an ink-jet printer that performs printing by ejecting ink as an example of the liquid to the medium 90. The medium 90 may be, for example, paper, cloth, vinyl, a plastic component, a metal component, or the like.

The liquid ejection apparatus 10 includes a liquid ejection unit 11. The liquid ejection unit 11 is configured to eject liquid onto the medium 90. The liquid ejection unit 11 includes a liquid ejection head 12. The liquid ejection head 12 ejects the liquid to the medium 90. The liquid ejection head 12 is configured to eject the liquid contained in a liquid container 50 described below.

The liquid ejection head 12 includes a plurality of nozzles 13. The liquid ejection head 12 performs printing by ejecting liquid onto the medium 90 from each of the plurality of nozzles 13. The liquid ejection head 12 may be of a serial type or a line type. The liquid ejection head 12 of a serial type performs printing by ejecting liquid onto the medium 90 while moving. The liquid ejection head 12 of a line type is provided in an elongated form in a width direction of the medium 90, and performs printing by ejecting liquid onto the medium 90.

The liquid ejection apparatus 10 may include a conveyance unit 14. The conveyance unit 14 is configured to convey the medium 90. The conveyance unit 14 conveys the medium 90 to the liquid ejection head 12 from a medium container not illustrated. The conveyance unit 14 conveys the medium 90 after the printing by the liquid ejection head 12 to the outside of the liquid ejection apparatus 10. The conveyance unit 14 may include a roller.

The liquid ejection apparatus 10 may include an attachment portion 20. The liquid container 50 is attachable to and detachable from the attachment portion 20. A plurality of the liquid containers 50 corresponding to the respective colors of the liquid may be attachable to the attachment portion 20. The liquid container 50 contains liquid to be supplied to the liquid ejection head 12. The liquid container 50 may be an ink cartridge.

The liquid ejection apparatus 10 may include a supply flow path 22. The liquid ejection apparatus 10 may include a plurality of the supply flow paths 22 corresponding to the respective colors of the liquid. The supply flow path 22 is a flow path for supplying liquid from the liquid container 50 to the liquid ejection head 12 when the liquid container 50 is attached to the attachment portion 20. When the liquid container 50 is attached to the attachment portion 20, an upstream end of the supply flow path 22 is coupled to the liquid container 50. A downstream end of the supply flow path 22 is coupled to the liquid ejection head 12.

The supply flow path 22 may enable the liquid contained in the liquid container 50 to be led out when a supply needle 23 is inserted into the liquid container 50 attached to the attachment portion 20. The supply flow path 22 may supply the liquid by means of hydraulic head. The liquid ejection apparatus 10 may include a pump (not illustrated) for supplying liquid from the liquid container 50 to the liquid ejection head 12.

The liquid ejection apparatus 10 may include a cap 30. The cap 30 can receive liquid discharged from the liquid ejection head 12. The cap 30 may be movable between a contact position illustrated in FIG. 1 and a separated position not illustrated. The contact position is a position at which the cap 30 is in contact with the liquid ejection head 12. The separated position is a position at which the cap 30 is separated from the liquid ejection head 12.

The cap 30 located at the contact position forms a closed space 31 to which each of the plurality of nozzles 13 opens. Maintenance performed with the cap 30 forming the closed space 31 surrounding the plurality of nozzles 13 is also referred to as capping.

The cap 30 at the separated position may receive liquid ejected from the liquid ejection head 12. Maintenance performed with the liquid ejection head 12 ejecting liquid is also referred to as flushing.

The liquid ejection apparatus 10 may include a cleaning unit 32. The cleaning unit 32 can perform cleaning. Cleaning is maintenance performed with liquid forcibly discharged from each of the plurality of nozzles 13 via the closed space 31. Thus, the cleaning unit 32 can forcibly discharge the liquid from the liquid ejection head 12.

The cleaning unit 32 may include a waste liquid flow path 33 and a suction pump 34. The waste liquid flow path 33 is a flow path for discharging liquid as waste liquid from the cap 30 to a waste liquid container 51 described below, when the waste liquid container 51 is attached to a waste liquid attachment portion 35. An upstream end of the waste liquid flow path 33 is coupled to the cap 30. When the waste liquid container 51 is attached to the waste liquid attachment portion 35, a downstream end of the waste liquid flow path 33 is coupled to the waste liquid container 51. The waste liquid flow path 33 may enable the liquid as the waste liquid to be led out from the waste liquid container 51 when a discharge needle 36 is inserted into the waste liquid container 51 attached to the waste liquid attachment portion 35.

The suction pump 34 can reduce the pressure in the space inside the cap 30 through the waste liquid flow path 33. The cleaning unit 32 performs cleaning by driving the suction pump 34 with the cap 30 located at the contact position. In other words, the cleaning unit 32 depressurizes the closed space 31. Accordingly, the liquid is discharged from each of the plurality of nozzles 13, and the liquid is supplied from the supply flow path 22 to the liquid ejection head 12.

The cleaning unit 32 may discharge the liquid in the cap 30 by driving the suction pump 34 with the cap 30 located at the separated position. Maintenance performed with the liquid in the cap 30 sent to the waste liquid container 51 described below is also referred to as idle suction.

The liquid ejection apparatus 10 may include the waste liquid attachment portion 35. The waste liquid container 51 is attachable to and detachable from the waste liquid attachment portion 35. The waste liquid container 51 can contain liquid as waste liquid discharged from the liquid ejection head 12 by the cleaning unit 32.

The liquid ejection apparatus 10 includes a liquid amount detection unit 37. For the waste liquid container 51, the liquid amount detection unit 37 detects that the contained amount of the waste liquid contained in the waste liquid container 51 has reached a threshold. The liquid amount detection unit 37 detects that the contained amount of the waste liquid contained in the waste liquid container 51 has reached an upper limit contained amount as the threshold. The liquid amount detection unit 37 may be sensors. The upper limit contained amount is a threshold of the contained amount that is an upper limit of the amount of the waste liquid that can be contained in the waste liquid container 51.

Specifically, the liquid amount detection unit 37 may be an optical sensor. The liquid amount detection unit 37 includes a light emitting portion AI and a light receiving portion 37B. The light emitting portion 37A emits light toward a reflection portion 55 of the waste liquid container 51 described below. The light receiving portion 37B receives light reflected from the reflection portion 55. The liquid amount detection unit 37 detects that the contained amount of the waste liquid contained in the waste liquid container 51 has reached the upper limit contained amount based on the light received by the light receiving portion 37B.

The liquid ejection apparatus 10 may include a container type detection unit 38. The container type detection unit 38 can detect that the waste liquid container 51 is or is not attached to the waste liquid attachment portion 35. The container type detection unit 38 can detect the type of the waste liquid container 51 attached to the waste liquid attachment portion 35. The container type detection unit 38 may be sensors.

The liquid ejection apparatus 10 includes a control unit 40 and an input unit 41. The liquid ejection apparatus 10 may include a notification unit 42. The control unit 40 comprehensively controls driving of each mechanism in the liquid ejection apparatus 10 and controls various operations performed in the liquid ejection apparatus 10.

The control unit 40 can be configured as a circuit including a: one or more processors that execute various processes in accordance with a computer program, β: one or more dedicated hardware circuits that execute at least some of the various processes, or y: a combination thereof. The hardware circuit is, for example, an application specific integrated circuit. The processor includes a CPU and a memory such as a RAM and a ROM, and the memory holds program codes or commands configured to cause the CPU to execute processing. The memory, i.e., a computer readable medium, includes any type of readable mediums that are accessible by general-purpose or dedicated computers.

The input unit 41 enables input of a predetermined instruction. The input unit 41 enables input of various instructions related to the liquid ejection apparatus 10. The input unit 41 is configured as an operation unit that can be operated by a user. Alternatively, the input unit 41 may be configured to receive a predetermined instruction input on a terminal device (not illustrated). In this case, the input unit 41 may be configured separately from the control unit 40 or may be configured to be included in the control unit 40.

The notification unit 42 issues a notification related to the liquid ejection apparatus 10. The notification unit 42 may be at least one of a display unit capable of displaying an image, a sound output unit capable of outputting sound, and a light emitting portion capable of emitting light in a predetermined light emitting mode. The notification unit 42 may not be provided in the liquid ejection apparatus 10 and may be provided in a terminal device (not illustrated). In this case, the control unit 40 may output a notification instruction to a terminal device (not illustrated), and the notification unit 42 may issue a notification based on the notification instruction.

In the present embodiment, the control unit 40 controls the liquid ejection unit 11, the conveyance unit 14, the cap 30, and the cleaning unit 32. Based on detection signals from the liquid amount detection unit 37 and the container type detection unit 38, the control unit 40 can recognize the detection result. The control unit 40 performs control based on an instruction input using the input unit 41. The control unit 40 causes the notification unit 42 to issue a notification related to the liquid ejection apparatus 10.

### Configuration of Waste Liquid Container 51

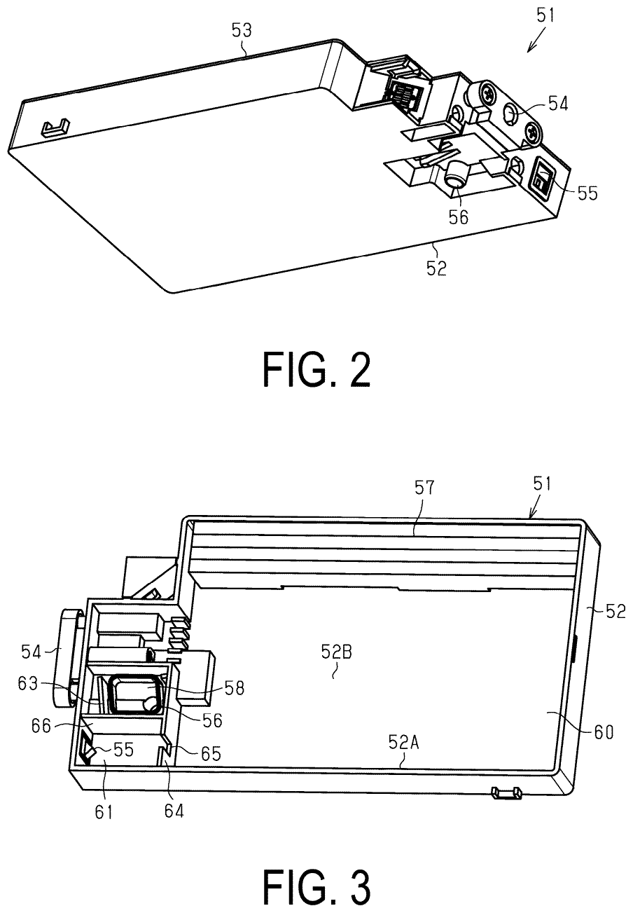

As illustrated in FIG. 2, the waste liquid container 51 is configured to contain the liquid ejected by the liquid ejection unit 11 as waste liquid. The waste liquid container 51 is replaceable with respect to the liquid ejection apparatus 10. The liquid ejection apparatus 10 may include the waste liquid container 51.

The waste liquid container 51 includes a waste liquid container case 52 and a waste liquid container cover 53. The waste liquid container case 52 is configured to contain waste liquid. The waste liquid container cover 53 is configured to cover the waste liquid container case 52 from above.

The waste liquid container case 52 includes an injection hole 54. The injection hole 54 is configured to enable injection of the liquid ejected by the liquid ejection unit 11 into the waste liquid container 51 as waste liquid. When the discharge needle 36 is inserted into the injection hole 54, the liquid as the waste liquid can be injected into the waste liquid container 51.

The waste liquid container case 52 includes the reflection portion 55. The reflection portion 55 is exposed from the waste liquid container case 52. The reflection portion 55 is provided at a position to face the liquid amount detection unit 37. The reflection portion 55 is a member for detecting that the waste liquid is or is not stored in a first storage portion 61 described below. The waste liquid stored in the first storage portion 61 changes a light reflection state of the reflection portion 55. The reflection portion 55 may be a prism.

The waste liquid container case 52 includes an atmosphere opening hole 56. Thus, the waste liquid container 51 includes the atmosphere opening hole 56. The atmosphere opening hole 56 may be provided on the outer bottom surface side of the waste liquid container case 52.

The atmosphere opening hole 56 communicates with the inside of the waste liquid container 51. The atmosphere opening hole 56 is a hole through which the inside of the waste liquid container case 52 opens to the atmosphere. The atmosphere opening hole 56 is provided to promote evaporation of the waste liquid contained in the waste liquid container 51. That is, the atmosphere opening hole 56 enables the evaporation of the waste liquid contained in the waste liquid container 51. The atmosphere opening hole 56 reduces the contained amount of the waste liquid contained in the waste liquid container 51 through the evaporation of the waste liquid. As a result, the amount of waste liquid that can be contained in the waste liquid container 51 increases.

As illustrated in FIG. 3, the waste liquid container case 52 includes a waste liquid containing portion 60, the first storage portion 61, and an atmosphere opening portion 63. Thus, the waste liquid container 51 includes the waste liquid containing portion 60, the first storage portion 61, and the atmosphere opening portion 63.

The waste liquid containing portion 60 can contain the waste liquid injected from the injection hole 54. In other words, the waste liquid containing portion 60 can contain the liquid ejected from the liquid ejection unit 11 as the waste liquid. The waste liquid containing portion 60 includes a waste liquid containing chamber that contains the waste liquid in the waste liquid container 51.

The waste liquid container case 52 includes an absorber 57. The absorber 57 is disposed in the waste liquid containing portion 60. In the drawing, a part of the absorber 57 is illustrated. The absorber 57 is a material that absorbs the waste liquid. The absorber 57 absorbs the waste liquid contained in the waste liquid containing portion 60.

The waste liquid container case 52 includes a first partition wall 64. The first partition wall 64 is provided between the waste liquid containing portion 60 and the first storage portion 61. The first partition wall 64 provides a partition between the waste liquid containing portion 60 and the first storage portion 61. The first partition wall 64 is provided between the waste liquid containing portion 60 and the atmosphere opening portion 63. The first partition wall 64 provides a partition between the waste liquid containing portion 60 and the atmosphere opening portion 63.

The first partition wall 64 is lower than an outer wall 52A of the waste liquid container case 52. Therefore, a gap is provided between the first partition wall 64 and the waste liquid container cover 53. Accordingly, the waste liquid containing portion 60 and the first storage portion 61 communicate with the atmosphere opening portion 63. Thus, the evaporation of the waste liquid contained in the waste liquid containing portion 60 and the first storage portion 61 is promoted through the atmosphere opening hole 56.

The first partition wall 64 includes a first communication portion 65. The first communication portion 65 is provided so as to establish communication between the waste liquid container 51 and the first storage portion 61. The first communication portion 65 is provided at a position higher than an inner bottom surface 52B of the waste liquid container case 52. The first communication portion 65 may have a recessed shape.

The first storage portion 61 is provided in a flow path through which the waste liquid containing portion 60 and the atmosphere opening hole 56 communicate. The first storage portion 61 can store the waste liquid. Specifically, the first storage portion 61 includes a first storage chamber capable of storing the waste liquid. The reflection portion 55 is provided in the first storage portion 61. The liquid amount detection unit 37 detects that the waste liquid of a first storage amount is contained in the first storage portion 61, by receiving the light reflected by the reflection portion 55. The first storage amount is an upper limit of the amount that can be contained in the first storage portion 61, but may be less than the upper limit amount. The contained amount of the waste liquid contained in the waste liquid containing portion 60 and the first storage portion 61 corresponds to the upper limit contained amount of the waste liquid contained in the waste liquid container 51.

The waste liquid container case 52 includes a second partition wall 66. The second partition wall 66 is provided between the first storage portion 61 and the atmosphere opening hole 56. The second partition wall 66 provides a partition between the first storage portion 61 and the atmosphere opening portion 63.

The second partition wall 66 is lower than the outer wall 52A of the waste liquid container case 52. Therefore, a gap is provided between the second partition wall 66 and the waste liquid container cover 53. Accordingly, the first storage portion 61 communicates with the atmosphere opening portion 63. Thus, the evaporation of the waste liquid contained in the first storage portion 61 is promoted through the atmosphere opening hole 56.

The atmosphere opening portion 63 is provided with the atmosphere opening hole 56. The atmosphere opening portion 63 includes a water-repellent ventilation film 58. The atmosphere opening hole 56 is provided with the water-repellent ventilation film 58. The water-repellent ventilation film 58 is a film that has water repellency but allows gas to pass therethrough.

By using the water-repellent ventilation film 58, the waste liquid contained in the waste liquid container 51 can be efficiently evaporated. By using the water-repellent ventilation film 58, it is possible to prevent the waste liquid from leaking to the outside of the waste liquid container 51 through the atmosphere opening hole 56 when a certain amount of waste liquid enters the atmosphere opening portion 63.

In this manner, the liquid ejected from the liquid ejection unit 11 is injected into the waste liquid container 51 through the injection hole 54. The waste liquid injected into the waste liquid container 51 is contained in the waste liquid containing portion 60. The waste liquid contained in the waste liquid containing portion 60 is absorbed by the absorber 57.

The waste liquid failed to be absorbed by the absorber 57 in the waste liquid containing portion 60 enters the first storage portion 61 via the first communication portion 65. The liquid amount detection unit 37 can detect that the waste liquid is or is not stored in the first storage portion 61, via the reflection portion 55. Specifically, the liquid amount detection unit 37 can detect that the waste liquid of the upper limit contained amount is or is not contained in the waste liquid container 51 via the reflection portion 55.

If the waste liquid is further injected into the waste liquid container 51 after the waste liquid of the upper limit contained amount has been contained in the waste liquid containing portion 60 and the first storage portion 61, the waste liquid overflowed from the waste liquid containing portion 60 and the first storage portion 61 enters the atmosphere opening portion 63. Therefore, when the contained amount of the waste liquid contained in the waste liquid container 51 reaches the upper limit contained amount, the waste liquid container 51 needs to be replaced.

### Waste Liquid Control Processing

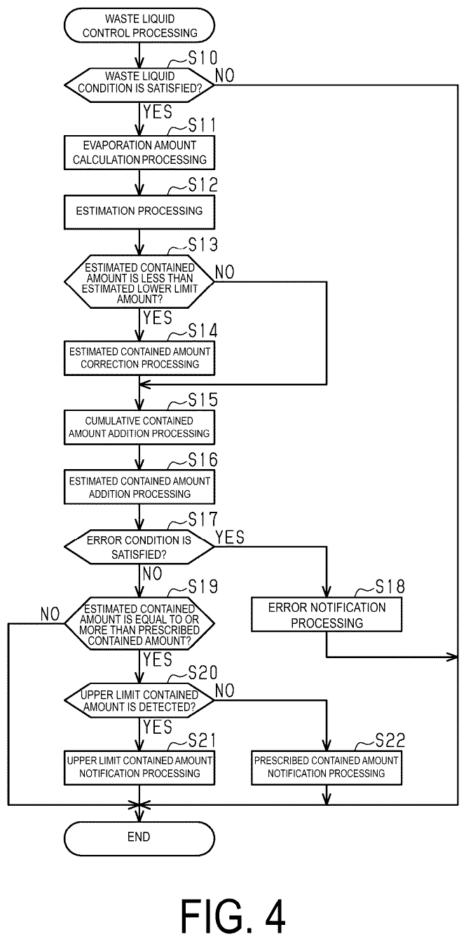

Waste liquid control processing will be described with reference to FIG. 4. The waste liquid control processing is processing executed by the control unit 40 at a predetermined cycle. The waste liquid control processing is processing of performing control related to the contained amount of the waste liquid contained in the waste liquid container 51.

As illustrated in FIG. 4, in step S10, the control unit 40 determines whether a waste liquid condition is satisfied. The waste liquid condition is satisfied when the maintenance is performed with the waste liquid led out to the waste liquid container 51. As a specific example, the waste liquid condition may be satisfied when cleaning is performed. Upon determining that the waste liquid condition is not satisfied, the control unit 40 terminates the waste liquid control processing. When the control unit 40 determines that the waste liquid condition is satisfied, the processing proceeds to step S11.

In step S11, the control unit 40 executes evaporation amount calculation processing. In this processing, the control unit 40 reads, from a memory, the elapsed time after the previous satisfaction of the waste liquid condition. The control unit 40 reads the evaporation rate from the memory. The evaporation rate indicates the evaporation amount per unit time. The control unit 40 calculates the evaporation amount of the waste liquid based on the elapsed time and the evaporation rate. Specifically, the control unit 40 calculates the product of the elapsed time and the evaporation rate as the evaporation amount of the waste liquid.

Thus, the control unit 40 calculates the evaporation amount of the waste liquid by which the waste liquid contained in the waste liquid container 51 evaporates from the waste liquid container 51 provided with the atmosphere opening hole 56. Such evaporation amount calculation processing corresponds to an example of calculation processing.

In step S12, the control unit 40 executes estimation processing. In this processing, the control unit 40 reads, from the memory, the contained amount of the waste liquid estimated at the point of the previous satisfaction of the waste liquid condition. The control unit 40 subtracts the evaporation amount of the waste liquid from the previous waste liquid contained amount. Thus, the control unit 40 estimates the current waste liquid contained amount not including the additional amount of the waste liquid. In this way, the control unit 40 estimates the contained amount of the waste liquid contained in the waste liquid container 51 based on the calculation result. Hereinafter, the contained amount of the waste liquid estimated by the control unit 40 is referred to as an estimated contained amount.

In step S13, the control unit 40 determines whether the estimated contained amount estimated in response to the current satisfaction of the waste liquid condition is less than the estimated lower limit amount. The control unit 40 calculates the product of a cumulative contained amount and a lower limit coefficient as the estimated lower limit amount. The cumulative contained amount is a cumulative amount of the waste liquid added to the waste liquid container 51 after the waste liquid container 51 has been attached to the waste liquid attachment portion 35. The estimated lower limit amount is a lower limit amount of the waste liquid, of the cumulative contained amount, estimated to remain without evaporating. The lower limit coefficient is a coefficient indicating a lower limit ratio of the waste liquid not evaporating.

The waste liquid contains ink, water, and a solvent at a predetermined ratio. When the waste liquid evaporates, water contained in the waste liquid evaporates, but the ink and the solvent do not evaporate at room temperature. Therefore, the lower limit coefficient is determined so as to correspond to the ratio of components other than water contained in the waste liquid. The lower limit coefficient may be 0.6 for example.

When the control unit 40 determines that the estimated contained amount is equal to or more than the estimated lower limit amount, the processing proceeds to step S15. When the control unit 40 determines that the estimated contained amount is less than the estimated lower limit amount, the processing proceeds to step S14.

In step S14, the control unit 40 executes estimated contained amount correction processing. In this processing, the control unit 40 corrects the estimated lower limit amount as the estimated contained amount. The control unit 40 stores the time when the waste liquid condition is satisfied and the estimated contained amount in the memory.

In step S15, the control unit 40 executes cumulative contained amount addition processing. In this processing, the control unit 40 calculates the additional amount of the waste liquid added when the waste liquid condition is satisfied. The additional amount of the waste liquid is an amount corresponding to the maintenance satisfying the waste liquid condition. As a specific example, when the cleaning is performed once, the additional amount of the waste liquid is an amount corresponding to the one cleaning. The control unit 40 records a result obtained by adding the calculated additional amount of the waste liquid to the cumulative contained amount in the memory as the current cumulative contained amount.

As described above, the control unit 40 calculates the additional amount of the waste liquid by which the liquid ejected by the liquid ejection unit 11 is added to the waste liquid container 51 as the waste liquid. This estimated contained amount addition processing corresponds to an example of the calculation processing.

In step S16, the control unit 40 executes estimated contained amount addition processing. In this processing, the control unit 40 records a result obtained by adding the calculated additional amount of the waste liquid to the estimated contained amount in the memory as the current estimated contained amount. In this way, the control unit 40 estimates the contained amount of the waste liquid contained in the waste liquid container 51 based on the calculation result and the additional amount of the waste liquid. The estimation processing and the estimated contained amount addition processing correspond to an example of estimation processing.

In step S17, the control unit 40 determines whether an error condition is satisfied. The error condition is satisfied when the estimated contained amount is equal to or more than an upper limit determination amount but the amount is detected by the liquid amount detection unit 37 to be not equal to or more than the upper limit contained amount. The upper limit determination amount is an amount with which the estimated contained amount can be assumed to have reached the upper limit contained amount. The upper limit determination amount may be equal to or more than the upper limit contained amount or may be less than the upper limit contained amount.

The error condition is satisfied when the estimated contained amount is equal to or less than a lower limit determination amount but the amount detected by the liquid amount detection unit 37 is equal to or more than the upper limit contained amount. The lower limit determination amount is an amount with which the estimated contained amount can be assumed to have not reached the upper limit contained amount yet. The lower limit determination amount is less than the upper limit contained amount.

When the control unit 40 determines that the error condition is satisfied, the processing proceeds to step S18. When the control unit 40 determines that the error condition is not satisfied, the processing proceeds to step S19.

In step S18, the control unit 40 executes error notification processing. In this processing, the control unit 40 makes the notification unit 42 issue an error notification related to the waste liquid. As described above, the control unit 40 makes the notification unit 42 issue an error notification related to the waste liquid contained in the waste liquid container 51, based on a result of the detection by the liquid amount detection unit 37 and a result of the estimation in step S12. Specifically, the control unit 40 makes the notification unit 42 issue a notification related to the contained amount of the waste liquid contained in the waste liquid container 51, based on a result of the estimation in step S12. This error notification processing corresponds to an example of notification processing.

In step S19, the control unit 40 determines whether the estimated contained amount is equal to or more than a prescribed contained amount. The prescribed contained amount is a threshold of the contained amount less than the upper limit contained amount. The prescribed contained amount is a threshold indicating that the contained amount almost reaches the upper limit contained amount, meaning that the waste liquid container 51 for replacement may be prepared.

Upon determining that the estimated contained amount is less than the prescribed contained amount, the control unit 40 terminates the waste liquid control processing. When the control unit 40 determines that the estimated contained amount is equal to or more than the prescribed contained amount, the processing proceeds to step S20.

In step S20, the control unit 40 determines whether the upper limit contained amount is detected as the contained amount of the waste liquid contained in the waste liquid container 51 based on the result of the detection by the liquid amount detection unit 37. Specifically, the control unit 40 determines that the contained amount of the waste liquid contained in the waste liquid container 51 has reached the threshold based on the result of the detection by the liquid amount detection unit 37. Such processing corresponds to an example of determination processing.

When the control unit 40 determines that the upper limit contained amount is detected, the processing proceeds to step S21. When the control unit 40 determines that the upper limit contained amount is not detected, the processing proceeds to step S22.

In step S21, the control unit 40 executes upper limit contained amount notification processing. In this processing, the control unit 40 makes the notification unit 42 issue a notification indicating that the upper limit contained amount has been reached. Thus, the control unit 40 makes the notification unit 42 issue the notification indicating that the contained amount of the waste liquid contained in the waste liquid container 51 has reached the upper limit contained amount, based on the result of the detection by the liquid amount detection unit 37. Specifically, the control unit 40 makes the notification unit 42 issue a notification related to the contained amount of the waste liquid contained in the waste liquid container 51, based on the result of the detection by the liquid amount detection unit 37. Such upper limit contained amount notification processing corresponds to an example of notification processing.

In step S22, the control unit 40 executes prescribed contained amount notification processing. In this processing, the control unit 40 makes the notification unit 42 issue a notification indicating that the upper limit contained amount has not been reached yet but the prescribed contained amount has been reached. Thus, the control unit 40 makes the notification unit 42 issue a notification indicating that the contained amount of the waste liquid contained in the waste liquid container 51 has reached the prescribed contained amount based on a result of estimation in step S12. Specifically, the control unit 40 makes the notification unit 42 issue a notification related to the contained amount of the waste liquid contained in the waste liquid container 51, based on a result of the estimation in step S12. Such prescribed contained amount notification processing corresponds to an example of notification processing.

The control unit 40 which initializes the cumulative contained amount and the estimated contained amount when the waste liquid container 51 is attached to the waste liquid attachment portion 35, may alternatively initialize the cumulative contained amount and the estimated contained amount when the waste liquid container 51 is detached from the waste liquid attachment portion 35.

### Transition of Estimated Contained Amount

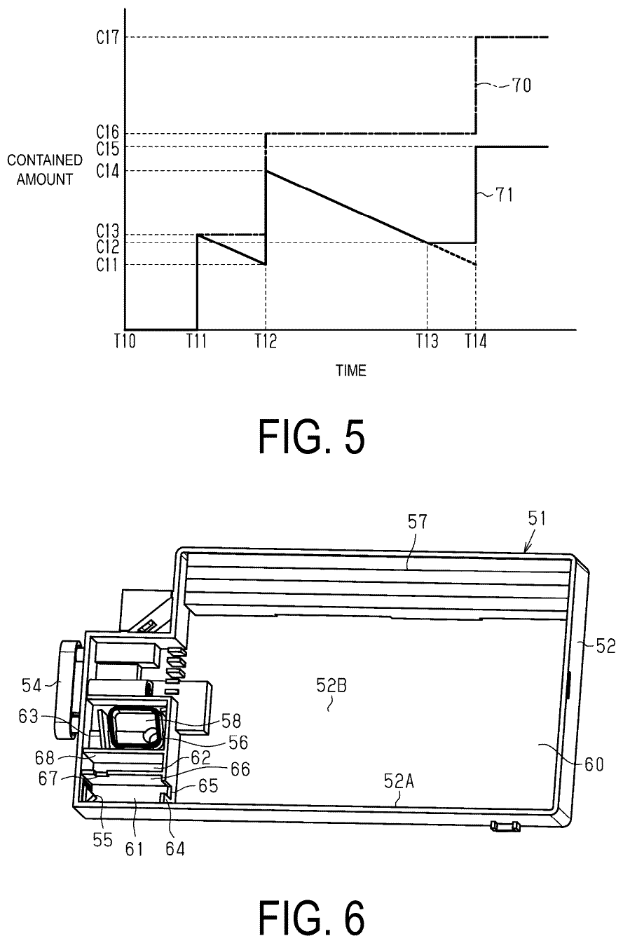

Transition of the estimated contained amount is described with reference to FIG. 5. Specifically, the relationship between the estimated contained amount and time will be described as transition of the estimated contained amount. In FIG. 5, a graph 70 is a graph illustrating a comparative example indicating the estimated contained amount estimated without considering the evaporation amount of the waste liquid. That is, the graph 70 is a graph corresponding to the calculation result of the cumulative contained amount. A graph 71 is a graph illustrating an example indicating an estimated contained amount estimated in consideration of the evaporation amount of the waste liquid.

As illustrated in FIG. 5, according to the graph 70 illustrating the comparative example, the waste liquid container 51 is attached to the waste liquid attachment portion 35 at a timing indicated by a reference numeral T10. As a result of adding the waste liquid to the waste liquid container 51 at a timing indicated by a reference numeral T11, the estimated contained amount of the waste liquid is calculated as a contained amount C13. Then, as a result of further adding the waste liquid to the waste liquid container 51 at a timing indicated by a reference numeral T12, the estimated contained amount of the waste liquid is calculated as a contained amount C16. Thereafter, as a result of the waste liquid being further added to the waste liquid container 51 at the timing indicated by a reference numeral T13, the estimated contained amount of the waste liquid is calculated as a contained amount C17.

In the graph 71 illustrating the example, the estimated contained amount of the waste liquid is calculated as a contained amount C11 at the timing indicated by the reference numeral T12 as a result of subtraction of the estimated contained amount of the waste liquid due to evaporation of the waste liquid after the timing indicated by the reference numeral T11. As a result of further adding the waste liquid to the waste liquid container 51 at a timing indicated by a reference numeral T12, the estimated contained amount of the waste liquid is calculated as a contained amount C14.

The estimated contained amount of the waste liquid is calculated as a contained amount C12 at a timing indicated by a reference numeral T13 as a result of subtraction of the estimated contained amount of the waste liquid due to evaporation of the waste liquid after the timing indicated by the reference numeral T12.

After the timing indicated by the reference numeral T13, the estimated contained amount becomes less than the estimated lower limit amount. In this case, the waste liquid is not evaporated, and the estimated contained amount of the waste liquid is maintained at the contained amount C12. As a result of further adding the waste liquid to the waste liquid container 51 at a timing indicated by a reference numeral T14, the estimated contained amount of the waste liquid is calculated as a contained amount C15.

As described above, according to the example in which the evaporation of the waste liquid is considered, the estimation accuracy of the estimated contained amount can be improved compared with the comparative example in which the evaporation of the waste liquid is not considered. Specifically, in a case where the contained amount C17 is the upper limit contained amount, the estimated contained amount reaches the upper limit contained amount in the comparative example, and there is a need to replace the waste liquid container 51 which is in a state of being capable of containing the waste liquid. On the other hand, in the example, the estimated contained amount does not reach the upper limit contained amount, and there is no need to replace the waste liquid container 51 which is in a state of being capable of containing the waste liquid.

### Operations and Effects of First Embodiment

Operations and effects of the first embodiment are described below.

(1-1) The liquid amount detection unit 37 detects that the contained amount of the waste liquid contained in the waste liquid container 51 has reached the upper limit contained amount. The control unit 40 calculates the evaporation amount of the waste liquid by which the waste liquid contained in the waste liquid container 51 evaporates through the atmosphere opening hole 56 provided in the waste liquid container 51. The control unit 40 estimates the contained amount of the waste liquid contained in the waste liquid container 51 based on the additional amount of the waste liquid added to the waste liquid container 51 and the calculation result. According to this configuration, in a case where the waste liquid container 51 provided with the atmosphere opening hole 56 is used, even if the contained amount of the waste liquid contained in the waste liquid container 51 decreases due to evaporation of the waste liquid, it can be determined that the contained amount of the waste liquid has reached the threshold based on the result of the detection by the liquid amount detection unit 37. Furthermore, the contained amount of the waste liquid contained in the waste liquid container 51 can be estimated based on the additional amount of the waste liquid and the evaporation amount of the waste liquid. Thus, the accuracy of the estimation for the contained amount of the waste liquid can be improved in consideration of the evaporation amount of the waste liquid, while improving the reliability of the recognition that the contained amount of the waste liquid has reached the threshold. Thus, improvement in the function related to the contained amount of the waste liquid contained in the waste liquid container 51 can be achieved.

(1-2) The control unit 40 makes the notification unit 42 issue a notification related to the contained amount of the waste liquid contained in the waste liquid container 51 based on the estimation result. According to this configuration, the notification can be issued related to the contained amount of the waste liquid estimated based on the additional amount of the waste liquid and the evaporation amount of the waste liquid. Accordingly, the user can be provided with information related to the contained amount of the waste liquid with improved estimation accuracy. Thus, improvement in the function related to the contained amount of the waste liquid contained in the waste liquid container 51 can be achieved.

(1-3) The control unit 40 makes the notification unit 42 issue a notification indicating that the contained amount of the waste liquid contained in the waste liquid container 51 has reached the prescribed contained amount based on a result of estimation. According to this configuration, it is possible to detect that the contained amount of the waste liquid has reached the upper limit contained amount by the liquid amount detection unit 37, and to issue the notification indicating that the contained amount of the waste liquid has reached the prescribed contained amount that is less than the upper limit contained amount. Accordingly, the contained amount of the waste liquid reaching the prescribed contained amount can be estimated with improved accuracy, while improving the reliability of the recognition that the contained amount of the waste liquid has reached the upper limit contained amount. Thus, improvement in the function related to the contained amount of the waste liquid contained in the waste liquid container 51 can be achieved.

(1-4) The control unit 40 makes the notification unit 42 issue an error notification related to the waste liquid contained in the waste liquid container 51, based on a result of the detection by the liquid amount detection unit 37 and a result of the estimation. According to this configuration, the error notification can be issued that is related to the waste liquid contained in the waste liquid container 51, by using both of the detection result with improved reliability and the estimation result with improved estimation accuracy. Thus, improvement in the function related to the contained amount of the waste liquid contained in the waste liquid container 51 can be achieved.

(1-5) The waste liquid container 51 is replaceable. According to this configuration, the contained amount of the waste liquid reaching the threshold can be reliably recognized, and the waste liquid container 51 can be replaced in accordance with the contained amount of the waste liquid estimated with improved accuracy. Thus, improvement in the function related to the contained amount of the waste liquid contained in the waste liquid container 51 can be achieved.

### Second Embodiment

Next, a second embodiment is described. In the following description, the overlapping description of the same configurations as those of the above-described embodiment will be omitted or simplified, and the configurations different from those of the above-described embodiment will be described.

### Configuration of Waste Liquid Container 51

As illustrated in FIG. 6, in the second embodiment, the waste liquid container case 52 includes a second storage portion 62. Thus, the waste liquid container 51 includes the second storage portion 62. The second storage portion 62 is provided in a flow path through which the first storage portion 61 and the atmosphere opening hole 56 communicate. The second storage portion 62 stores the waste liquid. Specifically, the second storage portion 62 includes a second storage chamber capable of storing the waste liquid.

The second storage portion 62 is capable of storing a predetermined contained amount of the waste liquid. The predetermined contained amount is obtained by subtracting the prescribed contained amount from the upper limit contained amount. The contained amount of the waste liquid contained in the waste liquid containing portion 60, the first storage portion 61, and the second storage portion 62 corresponds to the upper limit contained amount of the waste liquid in the waste liquid container 51.

The first partition wall 64 is provided between the waste liquid containing portion 60 and the second storage portion 62. The first partition wall 64 provides a partition between the waste liquid containing portion 60 and the second storage portion 62. Accordingly, the waste liquid containing portion 60, the first storage portion 61, and the atmosphere opening portion 63, communicate with the second storage portion 62, and evaporation of the waste liquid contained in the second reservoir 62 is promoted through the atmosphere opening hole 56.

The second partition wall 66 is provided between the first storage portion 61 and the second storage portion 62. The second partition wall 66 provides a partition between the first storage portion 61 and the second storage portion 62. The second partition wall 66 includes a second communication portion 67. The second communication portion 67 is provided to establish communication between the first storage portion 61 and the second storage portion 62. The second communication portion 67 is provided at a position higher than the inner bottom surface 52B of the waste liquid container case 52. The second communication portion 67 may have a recessed shape.

The first storage portion 61 is provided in a flow path through which the waste liquid containing portion 60 and the atmosphere opening hole 56 communicate. Specifically, the first storage portion 61 is provided in a flow path through which the waste liquid containing portion 60 and the second storage portion 62 communicate. The liquid amount detection unit 37 detects that the contained amount of the waste liquid has reached the prescribed contained amount as the threshold. The contained amount of the waste liquid contained in the waste liquid containing portion 60 and the first storage portion 61 corresponds to the prescribed contained amount of the waste liquid in the waste liquid container 51.

The waste liquid container case 52 includes a third partition wall 68. The third partition wall 68 is provided between the second storage portion 62 and the atmosphere opening hole 56. The third partition wall 68 provides a partition between the second storage portion 62 and the atmosphere opening portion 63.

The third partition wall 68 is lower than the outer wall 52A of the waste liquid container case 52. Therefore, a gap is provided between the third partition wall 68 and the waste liquid container cover 53. Accordingly, the second storage portion 62 communicates with the atmosphere opening portion 63. Thus, the evaporation of the waste liquid contained in the second storage portion 62 is promoted through the atmosphere opening hole 56.

The liquid amount detection unit 37 can detect that the waste liquid is or is not stored in the first storage portion 61, via the reflection portion 55. Specifically, the liquid amount detection unit 37 can detect that the waste liquid of the prescribed contained amount is or is not contained in the waste liquid container 51 via the reflection portion 55.

When the waste liquid is further injected into the waste liquid container 51 after the waste liquid of the prescribed contained amount has been contained in the waste liquid containing portion 60 and the first storage portion 61, the waste liquid stored in the first storage portion 61 enters the second storage portion 62 via the second communication portion 67.

If the waste liquid is further injected into the waste liquid container 51 after the waste liquid of the upper limit contained amount has been contained in the waste liquid containing portion 60, the first storage portion 61, and the second storage portion 62, the waste liquid overflowed from the waste liquid containing portion 60, the first storage portion 61, and the second storage portion 62 enters the atmosphere opening portion 63. Therefore, when the contained amount of the waste liquid contained in the waste liquid container 51 reaches the upper limit contained amount, the waste liquid container 51 needs to be replaced.

### Waste Liquid Control Processing

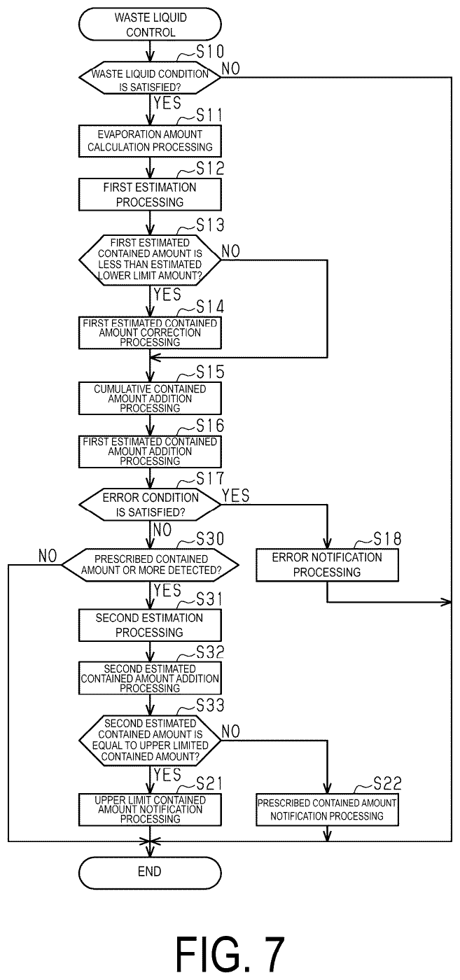

As illustrated in FIG. 7, in steps S12 to S17 of the waste liquid control processing, the control unit 40 controls the estimated contained amount of the first embodiment as a first estimated contained amount. In step S12, the control unit 40 executes first estimation processing in a manner similar to that for the estimation processing in the first embodiment. In step S13, as in the first embodiment, the control unit 40 determines whether the first estimated contained amount estimated when the current waste liquid condition is satisfied is less than the estimated lower limit amount. In step S14, the control unit 40 executes first estimated contained amount correction processing in a manner that is the same as that for the estimated contained amount correction processing in the first embodiment. In step S16, the control unit 40 executes first estimated contained amount addition processing in a manner similar to that for the estimated contained amount addition processing in the first embodiment.

In step S17 of the waste liquid control processing, the error condition is satisfied when the first estimated contained amount is equal to or more than the upper limit determination amount but the amount is detected by the liquid amount detection unit 37 to be not equal to or more than the prescribed contained amount. The upper limit determination amount is an amount with which the first estimated contained amount can be assumed to have reached the prescribed contained amount. The upper limit determination amount may be equal to or more than the prescribed contained amount or may be less than the prescribed contained amount. The error condition is satisfied when the first estimated contained amount is equal to or less than a lower limit determination amount but the amount detected by the liquid amount detection unit 37 is equal to or more than the prescribed contained amount. The lower limit determination amount is an amount with which the first estimated contained amount can be assumed to have not reached the prescribed contained amount yet. The lower limit determination amount is less than the prescribed contained amount. When the control unit 40 determines that the error condition is not satisfied, the processing proceeds to step S30.

In step S30, the control unit 40 determines whether the contained amount of the waste liquid contained in the waste liquid container 51 is detected to be equal to or more than the prescribed contained amount, based on the result of the detection of the liquid amount detection unit 37. Upon determining that the contained amount of the waste liquid being equal to or more than the prescribed contained amount is not detected, the control unit 40 terminates the waste liquid control processing. When the control unit 40 determines that the contained amount of the waste liquid is detected to be equal to or more than the prescribed contained amount, the processing proceeds to step S31.

In step S31, the control unit 40 executes second estimation processing. In this processing, the control unit 40 reads, from the memory, a second estimated contained amount of the waste liquid estimated at the point of the previous satisfaction of the waste liquid condition. The second estimated contained amount is a contained amount of waste liquid obtained as a sum of the prescribed contained amount and the contained amount of the waste liquid added to the waste liquid container 51 after the contained amount of the waste liquid has been detected to be equal to or more than the prescribed contained amount. The control unit 40 subtracts the evaporation amount of the waste liquid from the previous second estimated contained amount of the waste liquid. Thus, the control unit 40 estimates the current second estimated contained amount not including the additional amount of the waste liquid. In this way, the control unit 40 estimates the contained amount of the waste liquid contained in the waste liquid container 51 based on the calculation result.

In step S32, the control unit 40 executes second estimated contained amount addition processing. In this processing, the control unit 40 records a result obtained by adding the calculated additional amount of the waste liquid to the second estimated contained amount in the memory as the current second estimated contained amount.

In this way, the control unit 40 estimates the contained amount of the waste liquid contained in the waste liquid container 51 based on the calculation result and the additional amount of the waste liquid. The second estimation processing and the estimated contained amount addition processing correspond to an example of estimation processing.

In step S33, the control unit 40 determines whether the second estimated contained amount is equal to or more than the upper limit contained amount. When the control unit 40 determines that the second estimated contained amount is less than the upper limit contained amount, the processing proceeds to step S22. When the control unit 40 determines that the second estimated contained amount is equal to or more than the upper limit contained amount, the processing proceeds to step S21.

Thus, in step S22, the control unit 40 makes the notification unit 42 issue the notification indicating that the contained amount of the waste liquid contained in the waste liquid container 51 has reached the prescribed contained amount, based on the result of the detection by the liquid amount detection unit 37. Specifically, the control unit 40 makes the notification unit 42 issue a notification related to the contained amount of the waste liquid contained in the waste liquid container 51, based on the result of the detection by the liquid amount detection unit 37. Such prescribed contained amount notification processing corresponds to an example of notification processing.

In step S21, after the contained amount of the waste liquid contained in the waste liquid container 51 has reached the prescribed contained amount, the control unit 40 makes the notification unit 42 issue a notification indicating that the contained amount of the waste liquid contained in the waste liquid container 51 has reached the upper limit contained amount based on the result of estimation in step S31. Specifically, the control unit 40 makes the notification unit 42 issue a notification related to the contained amount of the waste liquid contained in the waste liquid container 51, based on a result of the estimation in step S31. Such prescribed contained amount notification processing corresponds to an example of notification processing.

The control unit 40 which initializes the second estimated contained amount when the waste liquid container 51 is attached to the waste liquid attachment portion 35, may alternatively initialize second estimated contained amount when the waste liquid container 51 is detached from the waste liquid attachment portion 35.

### Operations and Effects of Second Embodiment

Operations and effects of the second embodiment are described below.

(2-1) The liquid amount detection unit 37 can detect that the contained amount of the waste liquid has reached the prescribed contained amount, and a notification indicating that the contained amount of the waste liquid has reached the prescribed contained amount and the upper limit contained amount. Accordingly, the contained amount of the waste liquid reaching the upper limit contained amount can be estimated with improved accuracy, while improving the reliability of the recognition that the contained amount of the waste liquid has reached the prescribed contained amount. Thus, improvement in the function related to the contained amount of the waste liquid contained in the waste liquid container 51 can be achieved.

### Modifications

The embodiments may be modified as follows for implementation. The embodiments and modifications described below may be combined for implementation insofar as they are not technically inconsistent.
The control unit 40 may execute the waste liquid control processing before the liquid is ejected from the liquid ejection unit 11 as the waste liquid, or may execute the waste liquid control processing after the liquid has been ejected from the liquid ejection unit 11 as the waste liquid.
The control unit 40 may select an evaporation rate corresponding to the installation environment of the liquid ejection apparatus 10 from among a plurality of types of evaporation rates. The installation environment may include at least one of temperature and humidity. The liquid ejection apparatus 10 may include an environment detection unit that detects at least one of temperature and humidity. The control unit 40 may select the evaporation rate corresponding to the installation environment of the liquid ejection apparatus 10 as a result of referring to at least one of the installation environment at the time of previous satisfaction of the waste liquid condition and the installation environment at the time of current satisfaction of the waste liquid condition.
The control unit 40 may select an evaporation rate corresponding to the type of the waste liquid container 51 attached to the waste liquid attachment portion 35, from among a plurality of types of evaporation rates. The control unit 40 may determine the type of the waste liquid container 51 attached to the waste liquid attachment portion 35, based on the result of detection by the container type detection unit 38. The control unit 40 may select the evaporation rate corresponding to the shape of the atmosphere opening hole 56 provided in the waste liquid container 51. The control unit 40 may select an evaporation rate in accordance with the presence or absence of the atmosphere opening hole 56 in the waste liquid container 51. When the waste liquid container 51 provided with the atmosphere opening hole 56 is attached, the control unit 40 may select an evaporation rate higher than that in a case where the waste liquid container 51 not provided with the atmosphere opening hole 56 is attached.
The waste liquid condition may be satisfied when flushing is performed. The control unit 40 may select the additional amount of the waste liquid to be different between a case where the waste liquid condition is satisfied by cleaning and a case where the waste liquid condition is satisfied by flushing.
The liquid ejection apparatus 10 may include an additional amount detection unit that detects the additional amount of the waste liquid led out to the waste liquid container 51. Accordingly, the control unit 40 may acquire the additional amount of the waste liquid based on the detection result by the additional amount detection unit.
The liquid amount detection unit 37 is configured to include one prism, but is not limited thereto, and may include, for example, two or more prisms.
The liquid amount detection unit 37 may not be an optical sensor. The liquid amount detection unit 37 may detect the contained amount of the waste liquid contained in the waste liquid container 51 based on energization between electrodes. The liquid amount detection unit 37 may detect the contained amount of the waste liquid contained in the waste liquid container 51 based on the vibration waveform of the liquid detected by a piezoelectric sensor.
The liquid ejection apparatus 10 may include the waste liquid container 51. In this case, the waste liquid container 51 may or may not be detachable from the waste liquid attachment portion 35 of the liquid ejection apparatus 10.
The medium 90 may be paper, a resin film or a sheet, a composite film of a resin and a metal, a laminate film, a woven fabric, a nonwoven fabric, a metal foil, a metal film, a ceramic sheet, clothing, or the like.
Liquid can be arbitrarily selected as long as it can be recorded on the medium 90 by adhering to the medium 90. For example, ink includes various compositions such as an aqueous ink, an oil-based ink, a gel ink, a hot melt ink, or the like, including particles of a functional material made of a solid such as pigments or metal particles dissolved, dispersed or mixed in a solvent.
The liquid ejection apparatus 10 is not limited to an inkjet printer, and may be a dot impact printer.

The expression “at least one of” used in the specification means one or more of desired options. As an example, when the number of options is two, the expression “at least one of” used in the specification means only one option or both of the two options. As another example, when the number of options is three or more, the expression “at least one of” used in the specification means only one option or any combination of two or more options.

### Supplementary Note

The following is a description of the technical ideas and their effects that can be grasped from the above-described embodiments and modifications. This technical concept and its effects can be combined with each other to the extent that they are not technically inconsistent.

(A) A liquid ejection apparatus includes: a liquid ejection unit configured to eject liquid, a liquid amount detection unit configured to detect, in a waste liquid container capable configured to contain liquid ejected by the liquid ejection unit as waste liquid, that a contained amount of the waste liquid contained in the waste liquid container reaches a threshold, and a control unit, the control unit being configured to execute calculation processing of calculating an evaporation amount of waste liquid when waste liquid contained in the waste liquid container evaporates from the waste liquid container provided with an atmosphere opening hole, and estimation processing of estimating a contained amount of waste liquid contained in the waste liquid container, based on an additional amount of waste liquid when liquid ejected by the liquid ejection unit is added to the waste liquid container as waste liquid and a calculation result in the calculation processing.

According to this configuration, in a case where the waste liquid container provided with the atmosphere opening hole is used, even if the contained amount of the waste liquid contained in the waste liquid container decreases due to evaporation of the waste liquid, it can be determined that the contained amount of the waste liquid has reached the threshold based on the result of the detection by the liquid amount detection unit. Furthermore, the contained amount of the waste liquid contained in the waste liquid container can be estimated based on the additional amount of the waste liquid and the evaporation amount of the waste liquid. Thus, the accuracy of the estimation for the contained amount of the waste liquid can be improved in consideration of the evaporation amount of the waste liquid, while improving the reliability of the recognition that the contained amount of the waste liquid has reached the threshold. Thus, improvement in the function related to the contained amount of the waste liquid contained in the waste liquid container can be achieved.

(B) In the liquid ejection apparatus, the control unit may execute notification processing of causing a notification unit to issue a notification related to a contained amount of waste liquid contained in the waste liquid container, based on an estimation result in the estimation processing.

According to this configuration, the notification can be issued related to the contained amount of the waste liquid estimated based on the additional amount of the waste liquid and the evaporation amount of the waste liquid. Accordingly, the user can be provided with information related to the contained amount of the waste liquid with improved estimation accuracy. Thus, improvement in the function related to the contained amount of the waste liquid contained in the waste liquid container can be achieved.

(C) In the liquid ejection apparatus, the liquid amount detection unit may detect that a contained amount of waste liquid contained in the waste liquid container reaches an upper limit contained amount as the threshold, and the control unit may execute the notification processing of causing the notification unit to issue a notification indicating that a contained amount of waste liquid contained in the waste liquid container reaches a prescribed contained amount less than the upper limit contained amount, based on an estimation result in the estimation processing.

According to this configuration, it is possible to detect that the contained amount of the waste liquid has reached the upper limit contained amount by the liquid amount detection unit, and to issue the notification indicating that the contained amount of the waste liquid has reached the prescribed contained amount that is less than the upper limit contained amount. Accordingly, the contained amount of the waste liquid reaching the prescribed contained amount can be estimated with improved accuracy, while improving the reliability of the recognition that the contained amount of the waste liquid has reached the upper limit contained amount. Thus, improvement in the function related to the contained amount of the waste liquid contained in the waste liquid container can be achieved.

(D) In the liquid ejection apparatus, the waste liquid container may include: a waste liquid containing portion configured to contain liquid ejected from the liquid ejection unit as waste liquid, a first storage portion configured to store waste liquid in a flow path communicating the waste liquid containing portion and the atmosphere opening hole, and a reflection portion at which a reflection state of light is changed by waste liquid stored in the first storage portion, the liquid amount detection unit may be an optical sensor, the optical sensor may include a light emitting portion configured to emit light toward the reflection portion and a light receiving portion configured to receive the light reflected by the reflection portion, and the optical sensor may detect that a contained amount of waste liquid contained in the waste liquid container reaches the upper limit contained amount, based on light received by the light receiving portion. According to this configuration, the same effects as in (C) can be exhibited.

(E) In the liquid ejection apparatus, the liquid amount detection unit may detect that a contained amount of waste liquid contained in the waste liquid container reaches a prescribed contained amount as the threshold that is less than an upper limit contained amount, and the control unit may execute the notification processing of causing the notification unit to issue a notification indicating that a contained amount of waste liquid contained in the waste liquid container reaches the prescribed contained amount, based on a detection result by the liquid amount detection unit, and after a contained amount of waste liquid contained in the waste liquid container reaches the prescribed contained amount, causing the notification unit to issue a notification indicating that a contained amount of waste liquid contained in the waste liquid container reaches the upper limit contained amount, based on an estimation result in the estimation processing.

According to this configuration, the liquid amount detection unit can detect that the contained amount of the waste liquid has reached the prescribed contained amount less than the upper limit contained amount, and the notification indicating that the contained amount of the waste liquid has reached the prescribed contained amount and the upper limit contained amount can be issued. Accordingly, the contained amount of the waste liquid reaching the upper limit contained amount can be estimated with improved accuracy, while improving the reliability of the recognition that the contained amount of the waste liquid has reached the prescribed contained amount. Thus, improvement in the function related to the contained amount of the waste liquid contained in the waste liquid container can be achieved.

(F) In the liquid ejection apparatus, the waste liquid container may include: a waste liquid containing portion configured to contain liquid ejected from the liquid ejection unit as waste liquid, a first storage portion configured to store the waste liquid in a flow path communicating the waste liquid containing portion and the atmosphere opening hole, a second storage portion configured to store waste liquid in a flow path communicating the first storage portion and the atmosphere opening hole, and a reflection portion at which a reflection state of light is changed by waste liquid stored in the first storage portion, the second storage portion may be configured to store a predetermined contained amount of waste liquid, the predetermined contained amount may be obtained by subtracting the prescribed contained amount from the upper limit contained amount, the liquid amount detection unit may be an optical sensor, the optical sensor may include a light emitting portion configured to emit light toward the reflection portion and a light receiving portion configured to receive light reflected by the reflection portion, and the optical sensor may detect that a contained amount of waste liquid contained in the waste liquid container reaches the prescribed contained amount, based on the light received by the light receiving portion. According to this configuration, the same effects as in (E) can be exhibited.

(G) In the liquid ejection apparatus, the control unit may execute the notification processing of causing the notification unit to issue an error notification related to waste liquid contained in the waste liquid container, based on a detection result by the liquid amount detection unit and an estimation result in the estimation processing.

According to this configuration, the error notification can be issued that is related to the waste liquid contained in the waste liquid container, by using both of the detection result with improved reliability and the estimation result with improved estimation accuracy. Thus, improvement in the function related to the contained amount of the waste liquid contained in the waste liquid container can be achieved.

(H) In the liquid ejection apparatus, the waste liquid container may be replaceable.

According to this configuration, the contained amount of the waste liquid reaching the threshold can be reliably recognized, and the waste liquid container can be replaced in accordance with the contained amount of the waste liquid estimated with improved accuracy. Thus, improvement in the function related to the contained amount of the waste liquid contained in the waste liquid container can be achieved.

(I) The liquid ejection apparatus may include the waste liquid container configured to contain liquid ejected by the liquid ejection unit as waste liquid, and the waste liquid container may include the atmosphere opening hole configured to evaporate waste liquid contained in the waste liquid container therethrough. According to this configuration, the same effects as in (A) can be exhibited.

(J) A control method for a liquid ejection apparatus configured to perform control related to a contained amount of waste liquid that is liquid ejected by a liquid ejection unit and contained in a waste liquid container as waste liquid, the control method including executing: determination processing of determining that a contained amount of waste liquid contained in the waste liquid container reaches a threshold, based on a detection result by a liquid amount detection unit, calculation processing of calculating an evaporation amount of waste liquid when waste liquid contained in the waste liquid container evaporates from the waste liquid container provided with an atmosphere opening hole, and estimation processing of estimating a contained amount of waste liquid contained in the waste liquid container, based on an additional amount of waste liquid when liquid ejected by the liquid ejection unit is added to the waste liquid container as waste liquid and a calculation result in the calculation processing. According to this configuration, the same effects as in (A) can be exhibited.

What is claimed is:

1. A liquid ejection apparatus comprising:
a liquid ejection unit configured to eject liquid;
a liquid amount detection unit configured to detect, in a waste liquid container configured to contain liquid ejected by the liquid ejection unit as waste liquid, that a contained amount of waste liquid contained in the waste liquid container reaches a threshold; and
a control unit,
the control unit being configured to execute:
calculation processing of calculating an evaporation amount of waste liquid when waste liquid contained in the waste liquid container evaporates from the waste liquid container provided with an atmosphere opening hole; and
estimation processing of estimating a contained amount of waste liquid contained in the waste liquid container, based on an additional amount of waste liquid when liquid ejected by the liquid ejection unit is added to the waste liquid container as waste liquid and a calculation result in the calculation processing.

2. The liquid ejection apparatus according to claim 1, wherein the control unit executes notification processing of causing a notification unit to issue a notification related to a contained amount of waste liquid contained in the waste liquid container, based on an estimation result in the estimation processing.

3. The liquid ejection apparatus according to claim 2, wherein
the liquid amount detection unit detects that a contained amount of waste liquid contained in the waste liquid container reaches an upper limit contained amount as the threshold, and
the control unit executes the notification processing of causing the notification unit to issue a notification indicating that a contained amount of waste liquid contained in the waste liquid container reaches a prescribed contained amount less than the upper limit contained amount, based on an estimation result in the estimation processing.

4. The liquid ejection apparatus according to claim 3, wherein
the waste liquid container includes:
a waste liquid containing portion configured to contain liquid ejected from the liquid ejection unit as waste liquid;
a first storage portion configured to store waste liquid in a flow path communicating the waste liquid containing portion and the atmosphere opening hole; and
a reflection portion at which a reflection state of light is changed by waste liquid stored in the first storage portion,
the liquid amount detection unit is an optical sensor,
the optical sensor includes a light emitting portion configured to emit light toward the reflection portion and a light receiving portion configured to receive light reflected by the reflection portion, and
the optical sensor detects that a contained amount of waste liquid contained in the waste liquid container reaches the upper limit contained amount, based on light received by the light receiving portion.

5. The liquid ejection apparatus according to claim 2, wherein
the liquid amount detection unit detects that a contained amount of waste liquid contained in the waste liquid container reaches a prescribed contained amount as the threshold that is less than an upper limit contained amount, and
the control unit executes the notification processing of causing the notification unit to issue a notification indicating that a contained amount of waste liquid contained in the waste liquid container reaches the prescribed contained amount, based on a detection result by the liquid amount detection unit, and after a contained amount of waste liquid contained in the waste liquid container reaches the prescribed contained amount, causing the notification unit to issue a notification indicating that a contained amount of waste liquid contained in the waste liquid container reaches the upper limit contained amount, based on an estimation result in the estimation processing.

6. The liquid ejection apparatus according to claim 5, wherein
the waste liquid container includes:
a waste liquid containing portion configured to contain liquid ejected from the liquid ejection unit as waste liquid;
a first storage portion configured to store the waste liquid in a flow path communicating the waste liquid containing portion and the atmosphere opening hole;
a second storage portion configured to store waste liquid in a flow path communicating the first storage portion and the atmosphere opening hole; and
a reflection portion at which a reflection state of light is changed by waste liquid stored in the first storage portion,
the second storage portion is configured to store a predetermined contained amount of waste liquid,
the predetermined contained amount is obtained by subtracting the prescribed contained amount from the upper limit contained amount,
the liquid amount detection unit is an optical sensor,
the optical sensor includes a light emitting portion configured to emit light toward the reflection portion, and a light receiving portion configured to receive light reflected by the reflection portion, and
the optical sensor detects that a contained amount of waste liquid contained in the waste liquid container reaches the prescribed contained amount, based on the light received by the light receiving portion.

7. The liquid ejection apparatus according to claim 2, wherein the control unit executes the notification processing of causing the notification unit to issue an error notification related to waste liquid contained in the waste liquid container, based on a detection result by the liquid amount detection unit and an estimation result in the estimation processing.

8. The liquid ejection apparatus according to claim 1, wherein the waste liquid container is replaceable.

9. The liquid ejection apparatus according to claim 1, comprising the waste liquid container configured to contain liquid ejected by the liquid ejection unit as waste liquid, wherein
the waste liquid container includes the atmosphere opening hole configured to evaporate waste liquid contained in the waste liquid container therethrough.

10. A control method for a liquid ejection apparatus configured to perform control related to a contained amount of waste liquid that is liquid ejected by a liquid ejection unit and contained in a waste liquid container as waste liquid, the control method comprising executing:
determination processing of determining that a contained amount of waste liquid contained in the waste liquid container reaches a threshold, based on a detection result by a liquid amount detection unit;
calculation processing of calculating an evaporation amount of waste liquid when waste liquid contained in the waste liquid container evaporates from the waste liquid container provided with an atmosphere opening hole; and
estimation processing of estimating a contained amount of waste liquid contained in the waste liquid container, based on an additional amount of waste liquid when liquid ejected by the liquid ejection unit is added to the waste liquid container as waste liquid and a calculation result in the calculation processing.
